(19) United States
(12) Patent Application Publication
(10) Pub. No.: US 2017/0161295 A1
(43) Pub. Date: Jun. 8, 2017

(54) Fast Sparse Data Table Permutation

(71) Applicant: Microsoft Technology Licensing, LLC, Redmond, WA (US)

(72) Inventor: Elena Jocelyn Jakubiak, Arlington, MA (US)

(21) Appl. No.: 14/962,736

(22) Filed: Dec. 8, 2015

(51) Int. Cl. G06F 17/30; G06N 99/00; G06F 7/24

(52) U.S. Cl. CPC G06F 17/30153; G06F 17/30336; G06F 17/3033; G06F 7/24; G06N 99/005

(57) ABSTRACT

Efficiently creating compressed data representations. A method includes obtaining one or more source compressed data representations. The one or more source compressed data representations include source indices and source data elements corresponding to the source indices. The method further includes obtaining an identification of a selection of the one or more compressed data representations. The selection specifying indices from the source indices correlated to target indices for one or more target compressed data representations. The method further includes obtaining a mapping that maps the source indices from the selection to one or more target indices for the one or more target compressed data representations. The method further includes creating the target compressed data representations using the mapping.

### BACKGROUND

### Background and Relevant Art

Computers and computing systems have affected nearly every aspect of modern living. Computers are generally involved in work, recreation, healthcare, transportation, entertainment, household management, etc.

Computing resources are particularly useful for operating on large amounts of data to analyze the data and/or to produce useful results. One example where large amounts of data may be collected and operated on, is in machine learning contexts. Machine learning includes computing systems receiving data input and performing various operations on the data input. Machine learning systems can learn from the data, and make predictions on the data. For example, machine learning can look for patterns in data and then exploit those patterns in future data. Thus, machine learning systems make data driven predictions rather than simply performing static program instructions on input data. Here, large amounts of data are collected and analyzed. One such machine learning system is Azure ML Studio available from Microsoft, Corporation of Redmond, Wash.

Data tables in Azure ML Studio (and in other database systems) include a set of one or more columns. In some cases, there may be millions of columns and/or rows. Basic table operations, for instance those that might be used in SQL Server®, also available from Microsoft, Corporation of Redmond, Wash., often require re-ordering the rows of the tables, where each input row may appear zero or more times in an output table. As tables are stored by columns, such processes can take a long time. This can be especially true for sparse columns. Sparse columns (or rows) are columns (or rows) that have a significant portion of the column (or row) that contain default values and are therefore optimized by representing and storing the column (or row) as a list of index-value pairs. Thus, for example, a column having a data value of 7 at row 3, a data value of 18 at row 5000, and a data value of 1 at row 6789, with all other rows in the column having a default value would be represented as [3, 5000, 6789] [7, 18, 1]. When searching sparse columns, systems typically require O(log n) time to find a value for a given index. It would be useful if this time could be reduced such that operations on sparse data could be made more efficient.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a data processing environment. The method includes acts for efficiently creating compressed data representations. The method includes obtaining one or more source compressed data representations. The one or more source compressed data representations include source indices and source data elements corresponding to the source indices. The method further includes obtaining an identification of a selection of the one or more compressed data representations. The selection specifying indices from the source indices correlated to target indices for one or more target compressed data representations. The method further includes obtaining a mapping that maps the source indices from the selection to one or more target indices for the one or more target compressed data representations. The method further includes creating the target compressed data representations using the mapping.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a source sparse table;

FIG. 2 illustrates a target sparse table;

FIG. 3A illustrates the target sparse table in a compressed representation;

FIG. 3B illustrates a sorted target sparse table in a compressed representation;

FIG. 4 illustrates a source sparse table in a compressed representation;

FIG. 5 illustrates a getsclice command for specifying a selection of the sparse table;

FIG. 6 illustrates a simplified representation of a hash table;

FIG. 7A illustrates a target sparse table in a compressed representation;

FIG. 7B illustrates a sorted target sparse table in a compressed representation;

FIG. 8 illustrates a source sparse table in both compressed and uncompressed representations;

FIG. 9 illustrates a getsclice command for specifying a selection of the sparse table;

FIG. 10 illustrates a sparse table;

FIG. 11 illustrates a target sparse table in both compressed and uncompressed representations;

FIG. 12 illustrates a data processing system; and

FIG. 13 illustrates a method of efficiently creating compressed data representations.

### DETAILED DESCRIPTION

Embodiments herein may use a mapping of keys to values that has a constant time look-up, such as a hash table or dictionary, that maps source indices from a selection (such as a slice) to one or more target indices for one or more target compressed data representations (such as vectors). This mapping will be illustrated herein as a hash table, but it should be appreciated that any appropriate mapping, such as mappings that map keys to values with a constant time look-up, can be substituted for the hash table examples. This can be used to create target compressed data representations (in substantially linear time) by walking over non-sparse elements of one or more source compressed data representations and using the hash table to map elements from the source compressed data representations to the target compressed data representations.

This process makes it feasible to quickly permute, for example, the rows of a data table having sparse columns, for instance, when splitting or joining data tables.

In particular, embodiments can build a custom look-up hash table where the keys of the look-up hash table are the values that correspond to the indexes of the compressed data representations. By doing this, an output data representation (such as a data table and/or sparse vectors) can be constructed by iterating over the index-value pairs of the compressed data representations and performing a constant time look-up into the custom look-up hash table.

Several different examples, using different representations and characteristics of sparse data are now illustrated.

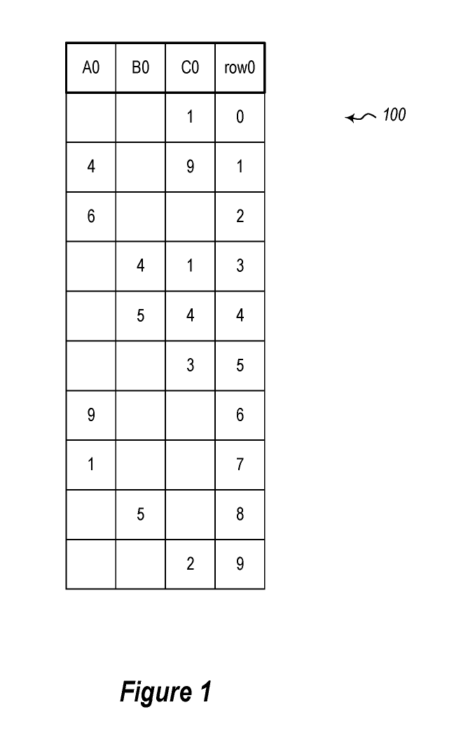

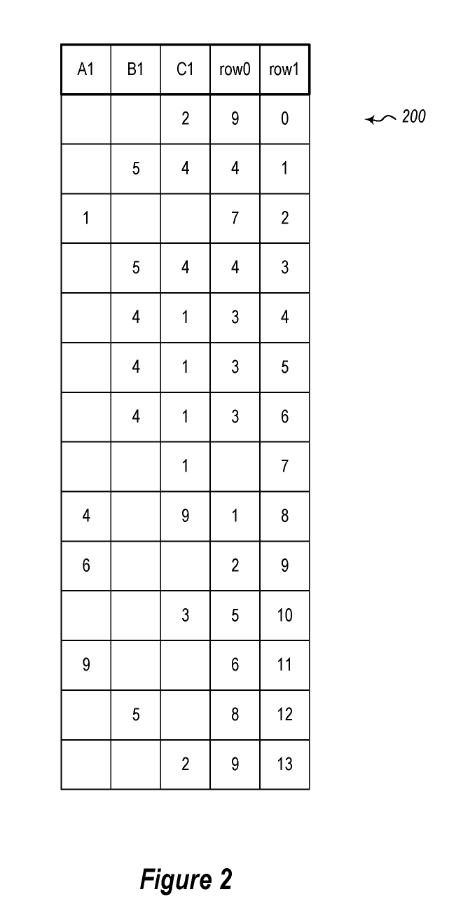

An example is now illustrated. FIG. 1 illustrates a table 100 with three columns as shown. Suppose, for the illustrated example, that a user wants an output table 200 as shown in FIG. 2. The user may indicate this intent by requesting a selection of the table 100. For example, in SQL Server® nomenclature and syntax, embodiments may use a ‘getslice’ command to identify a selection. In the example illustrated, the following getslice command may be instantiated:

getslice (9, 4, 7, 4, 3, 3, 3, 0, 1, 2, 5, 6, 8, 9)

This command specifies the index from the source table 100 that corresponds to the index for the target table 200, where the target table index is implicit based on position in the getslice command. In particular, this command specifies that a new target table 200 should be created where row 0 of the new target table 200 corresponds to row 9 of the source table 100, row 1 of the new target table 200 corresponds to row 4 of the source table 100, row 2 of the new target table 200 corresponds to row 7 of the source table 100, row 3 of the new target table 200 corresponds to row 4 of the source table 100, row 4 of the new target table 200 corresponds to row 3 of the source table 100, row 5 of the new target table 200 corresponds to row 3 of the source table 100, row 6 of the new target table 200 corresponds to row 3 of the source table 100, row 7 of the new target table 200 corresponds to row 0 of the source table 100, row 8 of the new target table 200 corresponds to row 1 of the source table 100, row 9 of the new target table 200 corresponds to row 2 of the source table 100, row 10 of the new target table 200 corresponds to row 5 of the source table 100, row 11 of the new target table 200 corresponds to row 6 of the source table 100, row 12 of the new target table 200 corresponds to row 8 of the source table 100, and row 13 of the new target table 200 corresponds to row 9 of the source table 100,

Using a sparse representation, the columns of the table 100 are stored as follows:

A: indices=[1, 2, 6, 7], values=[4, 6, 9, 1]
B: indices=[3, 4, 8], values=[4, 5, 5]
C: indices=[0, 1, 3, 4, 5, 9], values=[1, 9, 1, 4, 3, 2]

Previously, to convert column A0 to the desired output column A,1 the traditional method for the illustrated example is as follows:

// Define a new sparse column
SparseColumn A1
// Define a counter
counter = 0
// Iterate over the rows to create
For each row in output rows where INDEX = {9, 4, 7, 4, 3,
3, 3, 0, 1, 2, 5, 6, 8, 9}
// Do Binary Search on Column A0 to find the
value A0 [INDEX]
tmp = A0.Indexes.Find(INDEX) // This requires binary
search
val = A0.values[tmp]
// Add the value to the output column
A1.Indexes.Add(counter)
A2.Indexes.Add(val)

This method of creating new columns, as described above, typically takes an amount of time equal to O(log n) to find a value for a given index.

In contrast, embodiments implementing the following process can reduce the amount of time required to linear time for a given index. Embodiments obtain one or more compressed data representations (such as sparse vectors for columns of a sparse table). The one or more compressed data representations include source indices and source data elements corresponding to the source indices. Thus, in the example illustrated in FIG. 1, the compressed data representations represented as sparse vectors are A: [1, 2, 6, 7], [4, 6, 9, 1]; B: [3, 4, 8], [4, 5, 5]; and C: [0, 1, 3, 4, 5, 9], [1, 9, 1, 4, 3, 2].

Embodiments obtain an identification of a selection (such as a slice) of the one or more compressed data representations. The selection specifies indices of the one or more compressed data representations. The selection may specify indices to be split from the compressed data representations, combined with other compressed data representations, etc., to create target compressed data representations. For example, in SQL Server® nomenclature and syntax, embodiments may use a ‘slice’ command to identify a selection. In the example illustrated, the following slice command may be instantiated:

getslice (9, 4, 7, 4, 3, 3, 3, 0, 1, 2, 5, 6, 8, 9)

A computing system may obtain (such as by constructing) a hash table that maps the source indices from the selection to one or more target indices for the one or more target compressed data representations. In the present example, embodiments create the following simplified hash-table which maps source row numbers to target row numbers.

### HASH=

0->{7}
1->{8}
2->{9}
3->{4, 5, 6}
4->{1, 3}
5->{10}
6->{11}
7->{2}
8->{12}
9->{0, 13}

Note that in this example, the mapping is shown, but the hash or dictionary index is not shown. Those of skill in the art will appreciate that the mapping shown above is representative of the values in a hash table, although the actual layout structure of the hash table is not shown. In particular, to create a hash table, the source indices would be hashed, using a selected hash function that hashed each source index to a hash index, and then the target index or indices would be stored at the hash index in a hash table. However, for clarity, the hash table is shown with only the mapping from the source indices to the target indices.

Creating a hash table is done once per table as needed. The process then creates the target compressed data representations (typically in linear time) by walking over non-sparse elements of the one or more source compressed data representations and using the hash table to map elements from the source compressed data representations to the target compressed data representations. The following illustrates how this is implemented in the context of the present example:

// Iterate over the rows to create
For each indexValuePair in A0 : {1, 4}, {2,6 } {6, 9} {7, 1}
index = indexValuePair [0]
value = indexValuePair [1]
outputRows = HASH.Find(index) // This is constant time
for each row in outputRows
A1.Indexes.Add (row)
A2.Indexes.Add (value)

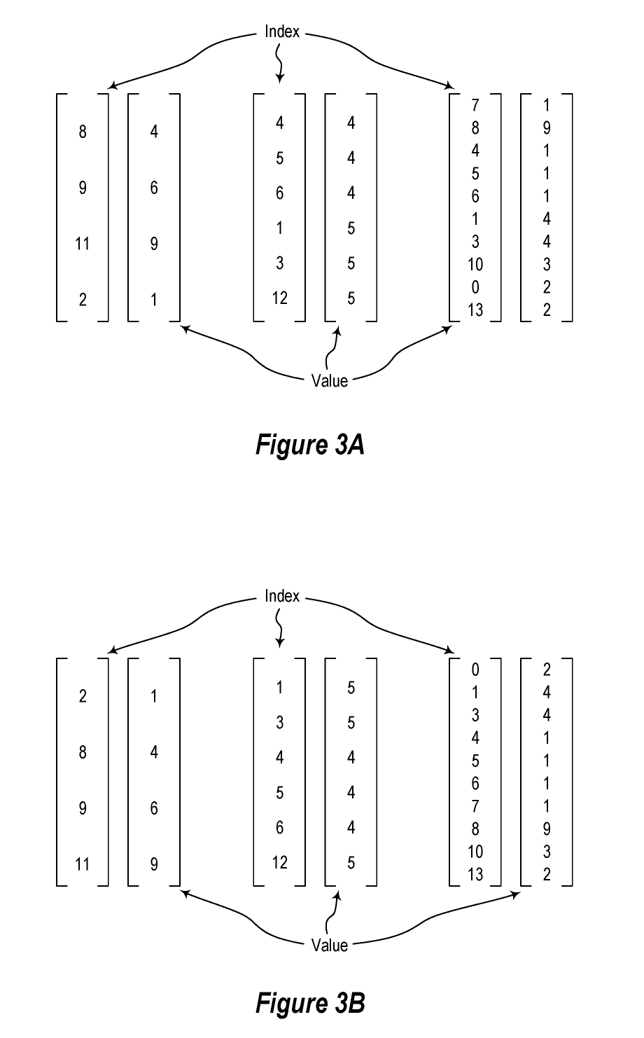

Illustratively, walking over non-sparse elements of the one or more source compressed data representations and using the hash table to map elements from the source compressed data representations to the target compressed data representations would result, in some embodiments in the compressed data representations illustrated in FIG. 3A. Note that in the present example, every row has some values, and thus walking over non-sparse elements results in walking over all rows of the table 100. However, this will likely not be true for many sparse data representations. FIG. 3B illustrates where further processing is performed to cause the sparse data representations to be sorted by index.

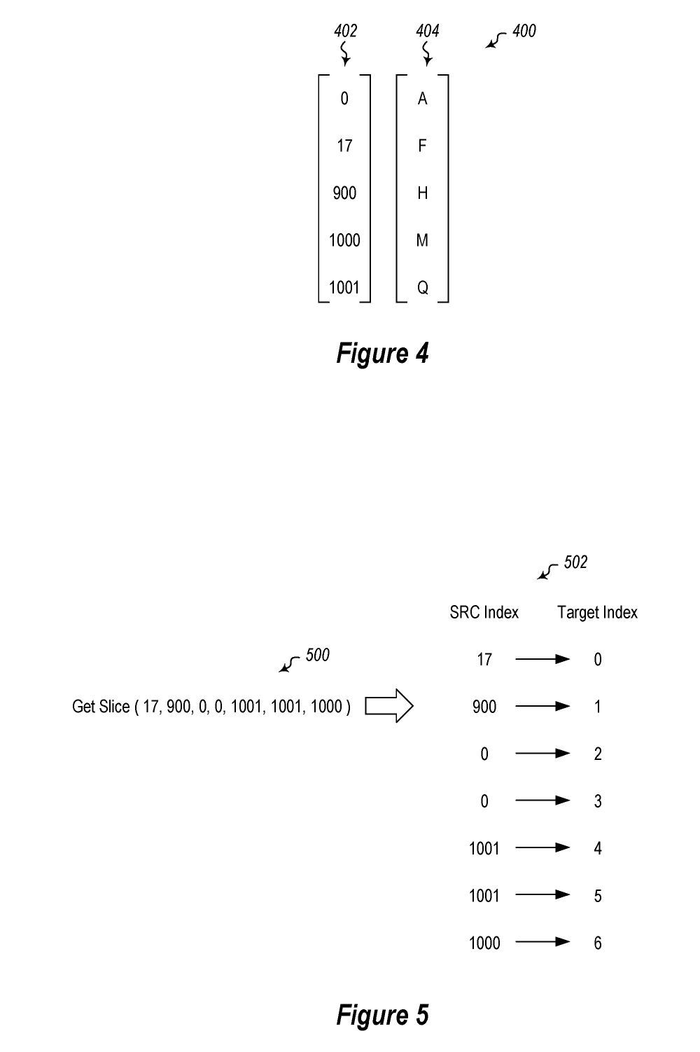

Referring now to FIGS. 4 through 8, another example is illustrated shown using only the compressed representation of a sparse table. FIG. 4 illustrates a sparse source table 400 including a single column illustrated in vector form, where the vector form includes an indices 402 and data elements 404.

FIG. 5 illustrates a slice command 500 that identifies rows from the sparse source table 400 to be included in a new target table. While not created in practice, FIG. 5 further illustrates a table 502 showing syntactical interpretation of the slice command 500. In particular, the table 502 shows the correlation between the indices 402 in the sparse source table 400 and the indices of the target table.

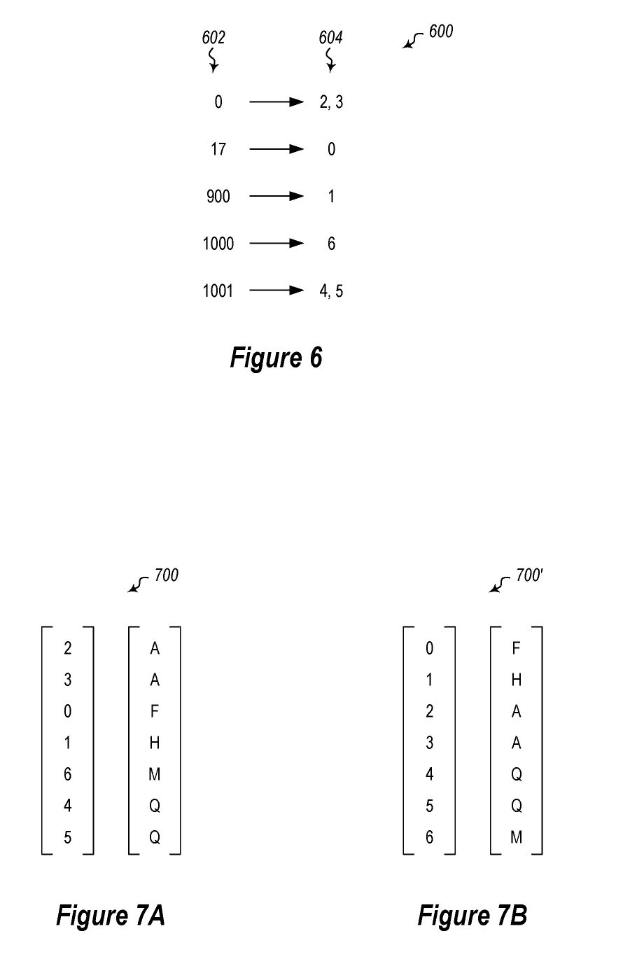

As illustrated in FIG. 6, a hash table 600 is created (as above, the illustrated table is a simplified representation of a hash table. The hash table 600 orders indices for dense source rows of the source table 400 as illustrated at 602. In some embodiments, the hash table 400 will only include indices for source rows that have data elements included in a target table. The hash table indexes indices for target rows (as can be identified by the slice command) (as illustrated at 604) to the indices for source rows.

Referring to FIG. 7A, a target table 700, represented as target compressed data representations, is created from the hash table 600 by walking over non-sparse elements of the one or more source compressed data representations and using the hash table to map elements from the source compressed data representations to the target compressed data representations. In the example illustrated, this can be done by using compressed data representations from the source table 400. This can be done for each row (or other selected dimension) serially, or all rows in parallel. Note that using the hash table 600, embodiments can simply walk through the indices in the table 400 to extract values for the target table 700.

FIG. 7B illustrates a table 700′ which is a sorted version of the table 100.

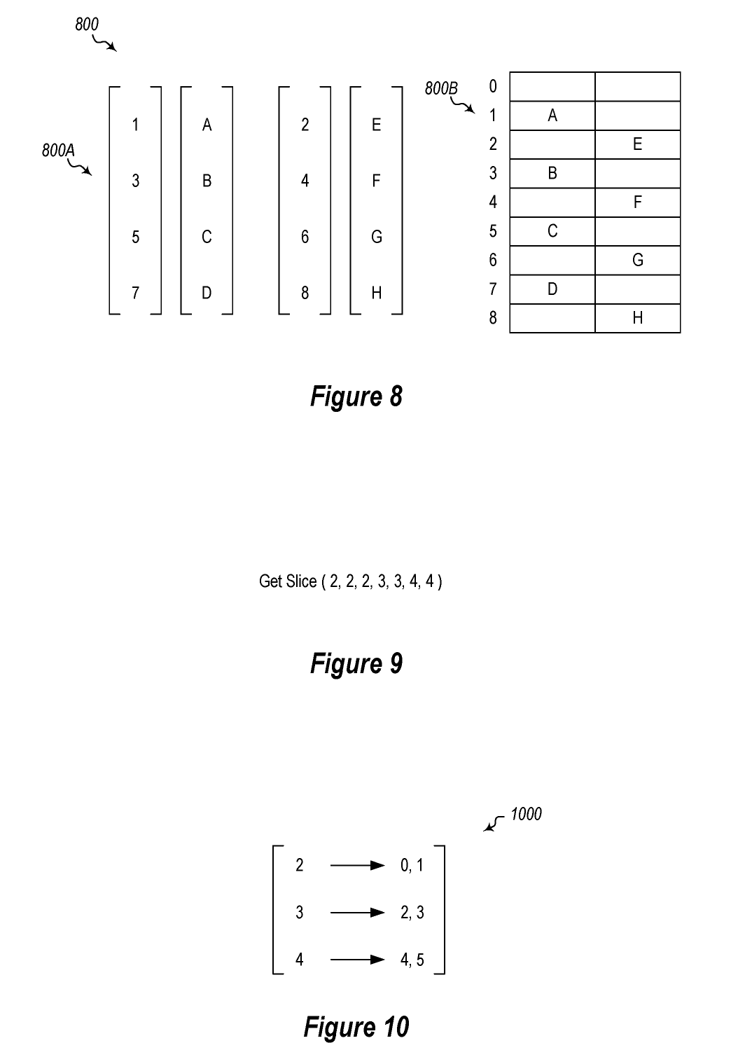

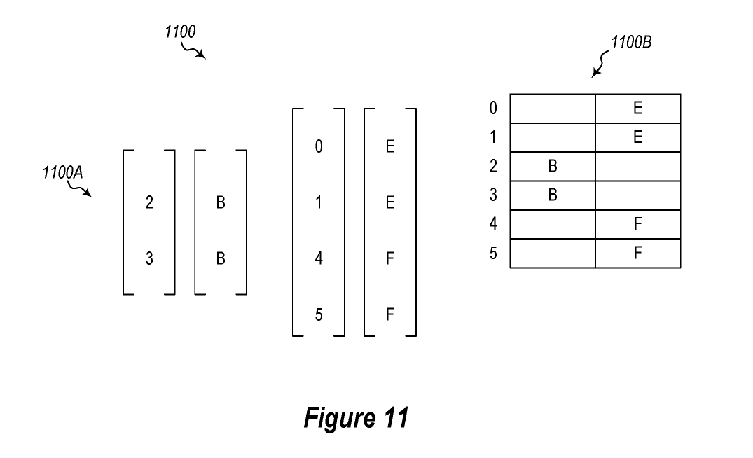

FIGS. 8-11 illustrate an example using a sparse representation of a table having two columns and 9 rows along with a traditional table representation, shown for clarity in understanding.

FIG. 8 illustrates a table 800 shown in both compressed form 800A and expanded form 800B. Suppose a user desires to specify a selection of the table 800, and does so by causing the getslice command 900 illustrated in FIG. 9 to be issued.

A data processing system will intercept the getslice command 900. Using the getslice command 900, the data processing system creates the hash table 1000 illustrated in FIG. 10.

The data processing system can then use the hash table 1000 to quickly generate the table 1100 (shown in both compressed form 1100A and uncompressed form 1100B) using the processes previously described herein.

The following illustrates time savings that can be achieved by using the new process disclosed herein as compared to previously used processes.

Time Complexity:

Let C=# columns in the input and output tables

Let R=# rows in the output table

Let Ni=# Non-zero values in a sparse column I (Ni is typically a fraction of R, say R/10, R/100, etc)

The traditional process requires O(R*Log(Ni)) operations per column, or sum(i=1, C) R*Log(Ni)

The new process requires O(Ni) operations per column+O(R) to build the look-up hash table, or R+sum(i=1, C) Ni

This time savings is significant, especially for large tables. For example, in one example test performed to compare two systems, one using previously known processes and one using the principles described herein, the time to process the data using the previous process was 2.5 hours, whereas using embodiments of the invention disclosed herein, processing time was reduced to 2 seconds for the same operations. Thus, experimental results have shown that embodiments of the invention can be used to create an improved computer system that uses less computing power to accomplish the same result as previous systems. In some embodiments, power savings could be achieved as lower power systems could be implemented and still achieve the same or better processing results as compared to previous systems not implementing the principles identified herein.

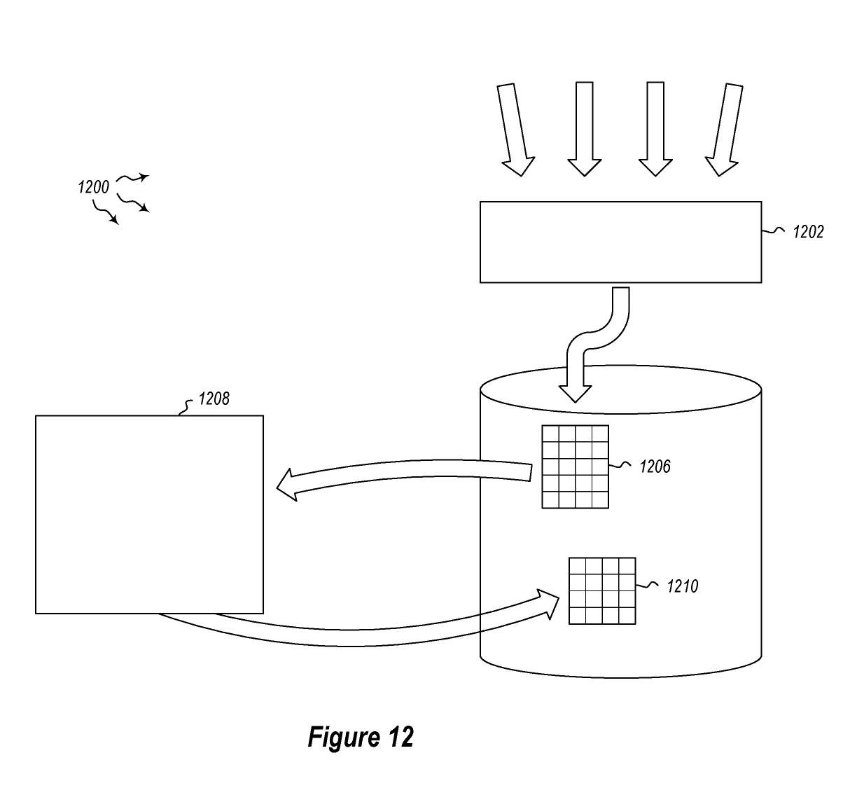

Referring now to FIG. 12, a system 1200 is illustrated. The system 1200 is a data processing system for collecting, analyzing, and operating on data. The system 1200 includes a data collection collector 1202 configured to collect data. The data collector 1202, may include, for example, instrumentation connected to data transmission hardware so as to be able to capture transmitted data. Alternatively or additionally the data collector 1202 may include data mining and harvesting instrumentation configured to crawl repositories of data and to collect data. The data collector 1202 feeds collected data into a mass storage device 1204, such as one or more hard drives or other storage devices. The data from the data collector is stored in a sparse table 1206, and is typically stored in a compressed format in the sparse table 1206 as illustrated in the examples above.

The system 1200 further includes a data processor 1208 configured to obtain data from the sparse table 1206 (or other tables) and to create a new table 1210. The new table 1210 may also be a sparse table. The data processor is configured to implement the specialized table construction illustrated above. In particular, the data processor may be configured to obtain one or more source compressed data representations, the one or more source compressed data representations comprising source indices and source data elements corresponding to the source indices; obtain an identification of a selection of the one or more compressed data representations, the selection specifying indices from the source indices correlated to target indices for one or more target compressed data representations; obtain a hash table that maps the source indices from the selection to one or more target indices for the one or more target compressed data representations; and create the target compressed data representations using the hash table.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

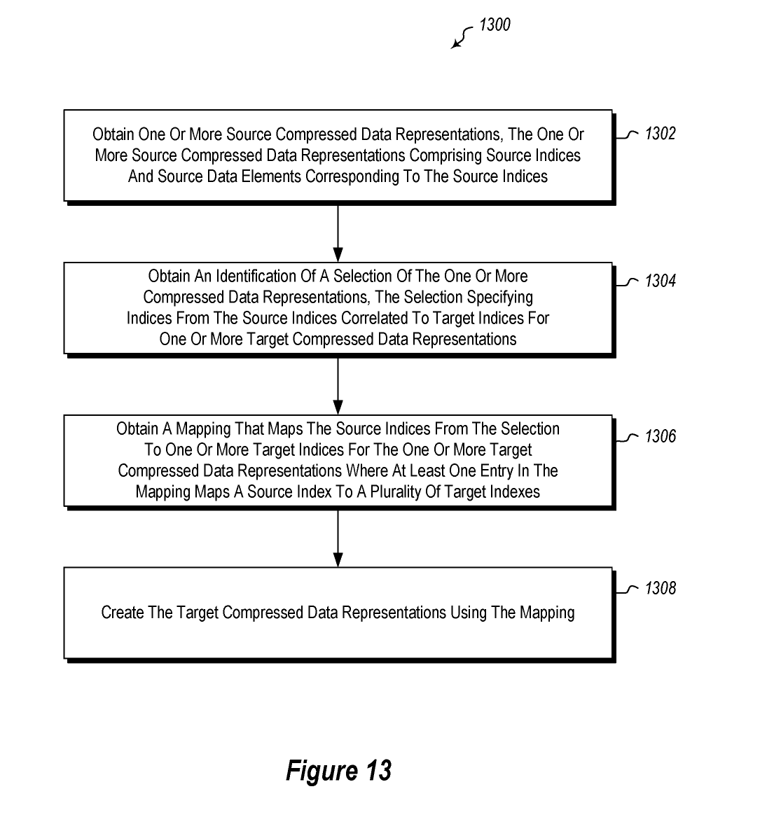

Referring now to FIG. 13, a method 1300 is illustrated. The method 1300 may be practiced in a data processing environment and includes acts for efficiently creating compressed data representations. The method includes obtaining one or more source compressed data representations (act 1302). The one or more source compressed data representations include source indices and source data elements corresponding to the source indices. For example, embodiments may obtain one or more sparse vectors such as the sparse vectors illustrated in FIG. 8.

The method 1300 further includes obtaining an identification of a selection of the one or more compressed data representations, the selection specifying indices from the source indices correlated to target indices for one or more target compressed data representations (act 1304). For example, embodiments may specify slices to be split from the sparse vectors and/or to be combined with other sparse vectors, etc.

The method 1300 further includes obtaining a mapping that maps the source indices from the selection to one or more target indices for the one or more target compressed data representations, where at least one entry in the mapping maps a source index to a plurality of target indexes (act 1306).

The method 1300 further includes creating the target compressed data representations using the mapping (act 1308).

The method 1300 may be practiced where obtaining one or more compressed data representations, includes obtaining one or more compressed data representations along a dimension. For example, a dimension may be a column or a row. Thus, for example, when one obtains a compressed data representation, one may obtain a compressed representation of a column. For example, FIG. 8 illustrates an example of compressed columns in the compressed form 800A of the table 800.

The method 1300 may be practiced where obtaining one or more compressed data representations, comprises obtaining one or more compressed data representations as part of obtaining a sparse table. Thus, for example, sparse columns may be naturally obtained as a user seeks to obtain a sparse table.

The method 1300 may be practiced where the identification of a selection of the one or more compressed data representations includes target indices for the target compressed representation corresponding to explicitly specified source indices for the source compressed data representations. In the examples illustrated above, the identification of a selection of the one or more compressed data representations includes implicitly specified target indices for the target compressed representation corresponding to explicitly specified source indices for source compressed representation. For example, in the slice commands illustrated previously, a target index is implicit based on position in the command, while the source index is explicitly identified.

The method 1300 may further include constructing the mapping by: walking over entries in the selection of one or more compressed data representations; for each entry in the selection that correlates a source index from the source indices to a target index, hashing the source index to obtain a hash table index for a hash table and storing the corresponding target index at the hash index in the hash table.

The method 1300 may be practiced where creating the target compressed data representations using the mapping includes walking over non-sparse elements of the one or more source compressed data representations and using the mapping to map elements from the source compressed data representations to the target compressed data representations.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
one or more processors; and
one or more computer-readable media having stored thereon instructions that are executable by the one or more processors to configure the computer system to efficiently create compressed data representations, including instructions that are executable to configure the computer system to perform at least the following:
obtaining one or more source compressed data representations, the one or more source compressed data representations comprising source indices and source data elements corresponding to the source indices;
obtaining an identification of a selection of the one or more compressed data representations, the selection specifying indices from the source indices correlated to target indices for one or more target compressed data representations;
obtaining a mapping that maps the source indices from the selection to one or more target indices for the one or more target compressed data representations, wherein at least one entry in the mapping maps a source index to a plurality of target indices; and
creating the target compressed data representations using the mapping.

2. The system of claim 1, wherein obtaining one or more compressed data representations, comprises obtaining one or more compressed data representations along a dimension.

3. The system of claim 1, wherein obtaining one or more compressed data representations, comprises obtaining one or more compressed data representations as part of obtaining a sparse table.

4. The system of claim 1, wherein the identification of a selection of the one or more compressed data representations includes target indices for the target compressed representation corresponding to explicitly specified source indices for the source compressed data representations.

5. The system of claim 1, wherein the one or more computer-readable media further have stored thereon instructions that are executable by the one or more processors to configure the computer system to construct the hash table by performing the following:
walking over entries in the selection of one or more compressed data representations; and
for each entry in the selection that correlates a source index from the source indices to a target index, hashing the source index to obtain a hash table index for a hash table and storing the corresponding target index at the hash index in the hash table.

6. The system of claim 1, wherein the identification of a selection of the one or more compressed data representations includes implicitly specified target indices for the target compressed representation corresponding to explicitly specified source indices for source compressed representation.

7. The system of claim 1, wherein creating the target compressed data representations using the mapping comprises:
walking over non-sparse elements of the one or more source compressed data representations; and
using the mapping to map elements from the source compressed data representations to the target compressed data representations.

8. In a data processing environment, a method of efficiently creating compressed data representations, the method comprising:
obtaining one or more source compressed data representations, the one or more source compressed data representations comprising source indices and source data elements corresponding to the source indices;
obtaining an identification of a selection of the one or more compressed data representations, the selection specifying indices from the source indices correlated to target indices for one or more target compressed data representations;
obtaining a mapping that maps the source indices from the selection to one or more target indices for the one or more target compressed data representations, wherein at least one entry in the mapping maps a source index to a plurality of target indices; and
creating the target compressed data representations using the mapping.

9. The method of claim 8, wherein obtaining one or more compressed data representations, comprises obtaining one or more compressed data representations along a dimension.

10. The method of claim 8, wherein obtaining one or more compressed data representations, comprises obtaining one or more compressed data representations as part of obtaining a sparse table.

11. The method of claim 8, wherein the identification of a selection of the one or more compressed data representations includes target indices for the target compressed representation corresponding to explicitly specified source indices for the source compressed data representations.

12. The method of claim 8, further comprising constructing the hash table by:
creating a correlation of target indices from the selection for the target compressed representation to source indices for the source compressed data representation;
sorting the created correlation by source indices for the source compressed data representation, and
combining any correlation entries having the same source index.

13. The method of claim 8, wherein the identification of a selection of the one or more compressed data representations includes implicitly specified target indices for the target compressed representation corresponding to explicitly specified source indices for source compressed representation.

14. The method of claim 8, wherein creating the target compressed data representations using the mapping comprises:
walking over non-sparse elements of the one or more source compressed data representations; and
using the mapping to map elements from the source compressed data representations to the target compressed data representations.

15. A system comprising:
a data collector, wherein the data collector is configured to collect data;
a storage device coupled to the data collector, wherein the data collector is configured to store collected data in one or more sparse data representations on the storage device;
a data processor, wherein the data processor is configured to perform the following:
obtain one or more source compressed data representations, the one or more source compressed data representations comprising source indices and source data elements corresponding to the source indices;
obtain an identification of a selection of the one or more compressed data representations, the selection specifying indices from the source indices correlated to target indices for one or more target compressed data representations;
obtain a mapping that maps the source indices from the selection to one or more target indices for the one or more target compressed data representations; and
create the target compressed data representations using the mapping.

16. The system of claim 15, wherein obtaining one or more compressed data representations, comprises obtaining one or more compressed data representations along a dimension.

17. The system of claim 15, wherein obtaining one or more compressed data representations, comprises obtaining one or more compressed data representations as part of obtaining a sparse table.

18. The system of claim 15, wherein the identification of a selection of the one or more compressed data representations includes target indices for the target compressed representation corresponding to explicitly specified source indices for the source compressed data representations.

19. The system of claim 15, wherein the data processor is configured to construct the mapping by performing the following:
creating a correlation of target indices from the selection for the target compressed representation to source indices for the source compressed data representation;
sorting the created correlation by source indices for the source compressed data representation, and
combining any correlation entries having the same source index.

20. The system of claim 15, wherein the identification of a selection of the one or more compressed data representations includes implicitly specified target indices for the target compressed representation corresponding to explicitly specified source indices for source compressed representation.
